(19) United States
(12) Patent Application Publication
(10) Pub. No.: US 2019/0050930 A1
(43) Pub. Date: Feb. 14, 2019

(54) RECOMMENDING APPLICATIONS BASED ON SEARCH HISTORIES

(71) Applicant: Microsoft Technology Licensing, LLC, Redmond, WA (US)

(72) Inventors: Felix Gerard Torquil Ifor ANDREW, Seattle, WA (US); Jeff WEST, Sammamish, WA (US); Silvana P. MONCAYO, Seattle, WA (US)

(21) Appl. No.: 15/676,863

(22) Filed: Aug. 14, 2017

(51) Int. Cl. G06Q 30/06; G06Q 30/02; G06F 17/30; G06F 9/445

(52) U.S. Cl. CPC G06Q 30/0631; G06Q 30/0201; G06F 8/60; G06F 17/30038; G06F 17/30029

(57) ABSTRACT

Search histories of users are collected and correlated with the application download or usage history of the users to identify queries that are correlated with the use of particular applications. The search histories can come from a variety of sources such as map applications and web browsing applications. The correlations are used to generate a mapping of queries to applications. The mapping can be later used to recommend applications to a user based on a recent query submitted by the user or based on a subset of the search history of the user. In this way, a user can be recommended applications based on their interests as expressed through their search history.

### BACKGROUND

Users of computing devices are able to download and run many different types of applications. To obtain applications, users typically visit an application store where the users may browse available applications, and may search for applications that may be of interest to them. The users may select and download one or more applications to their computing devices from the application store.

Because of the large number of applications that are available, it can be difficult for users to discover new applications, and to decide which applications that they may be interested in downloading. One solution to this problem is to present the user with the most popular applications that are available on the application store. The user can then explore the applications that are popular with other users. However, this solution assumes that the user is interested in the same applications as other users.

Another solution to this problem is to present the user with applications that have been downloaded by users who have downloaded some of the same applications as the user. However, this solution is not suitable for users who have downloaded few applications.

### SUMMARY

Search histories of users are collected and correlated with the application download or usage history of the users to identify queries that are correlated with the use of particular applications. The search histories can come from a variety of sources such as map applications and web browsing applications. The correlations are used to generate a mapping of queries to applications. The mapping can be later used to recommend applications to a user based on a recent query submitted by the user, or based on a subset of the search history of the user. In this way, a user can be recommended applications based on their interests as expressed through their search history.

In an implementation, a system for recommending applications based on search histories and application histories is provided. The system includes at least one computing device and an application engine. The application engine may be adapted to: for each user of a plurality of users, receive a search history for the user, wherein the search history for each user of the plurality of users comprises a plurality of queries submitted by the user of the plurality of users; for each user of the plurality of users, receive an application history for the user, wherein the application history for each user of the plurality of users comprises a plurality of applications downloaded by the user; using the received search histories and the received application histories, determine one or more applications of the received application histories that are correlated with at least one query from one or more of the received search histories; receive the at least one query from a first user of the plurality of users; and in response to receiving the at least one query from the first user of the plurality of users, generate a recommendation of the one or more applications that are correlated with the at least one query.

In an implementation, a system for recommending applications based on search histories and application histories is provided. The system may include at least one computing device and an application engine. The application engine may be adapted to: for each user of a plurality of users, receive a search history for the user, wherein the search history for each user of the plurality of users comprises a plurality of queries submitted by the user of the plurality of users; for each user of the plurality of users, receive an application history for the user, wherein the application history for each user of the plurality of users comprises a plurality of applications downloaded by the user; using the received search histories and the received application histories, generate a mapping of queries from the received search histories to applications from the received application histories; receive an identifier of a first user of the plurality of users; retrieve a search history of the first user; using the search history of the first user and the generated mapping, identify one or more applications from the received application histories; and generate a recommendation of the one or more applications.

In an implementation, a method for recommending applications based on search histories and application histories is provided. The method includes: for each user of a plurality of users, receiving a search history for the user by a first computing device, wherein the search history for each user of the plurality of users comprises a plurality of queries submitted by the user of the plurality of users; for each user of the plurality of users, receiving an application history for the user by the first computing device, wherein the application history for each user of the plurality of users comprises a plurality of applications downloaded by the user; using the received search histories and the received application histories, generating a mapping of queries from the received search histories to applications from the received application histories by the first computing device; receiving at least one query from a first user of the plurality of users by the first computing device; using the received at least one query and the generated mapping, identifying an application from the received application histories by the first computing device; determining that the first user has not previously downloaded the identified application to a second computing device based on the application history associated with the first user by the first computing device; and in response to the determination, generating a recommendation of the identified application by the first computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for recommending applications based on search histories and application histories;

FIG. 2 is an illustration of an implementation of an exemplary application engine;

FIGS. 3-5 are illustrations of an example user interface for recommending applications in response to queries based on search histories and application histories;

FIG. 6 is an operational flow of an implementation of a method for recommending one or more applications based on a received query;

FIG. 7 is an operational flow of an implementation of a method for recommending one or more applications based on a search history;

FIG. 8 is an operational flow of an implementation of a method for recommending an application that a user has not previously downloaded and whose expiration date has not passed based on search histories and application histories; and

FIG. 9 shows an exemplary computing environment in which example embodiments and aspects may be implemented.

### DETAILED DESCRIPTION

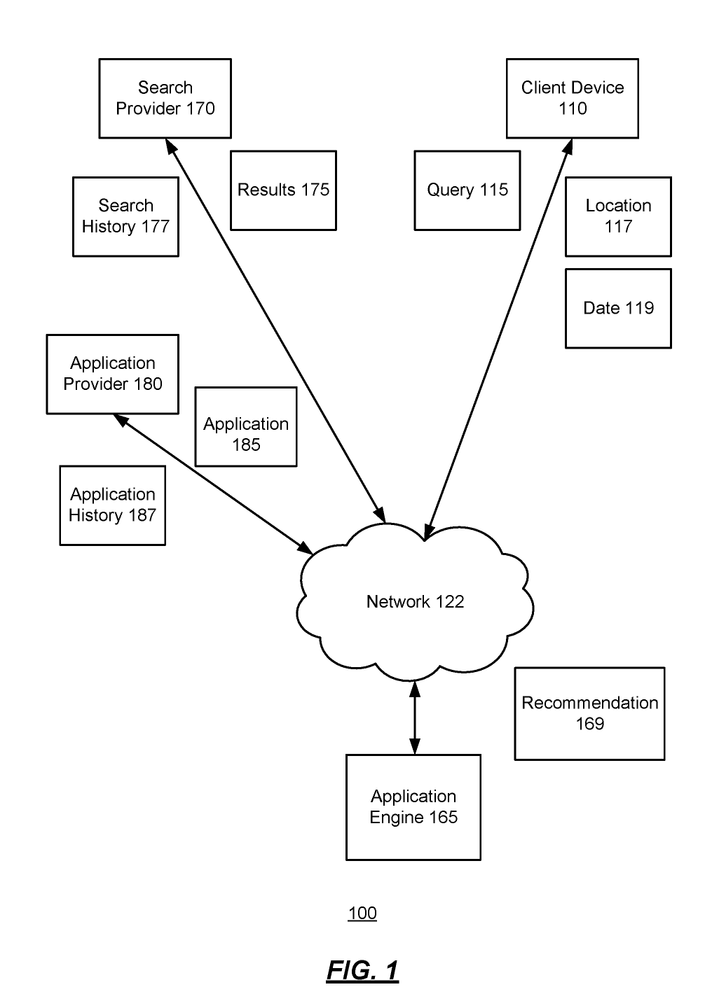

FIG. 1 is an illustration of an exemplary environment 100 for recommending applications based on search histories and application histories. The environment 100 may include an application engine 165, one or more search providers 170, one or more application providers 180, and one or more client devices 110 in communication through a network 122. The network 122 may be a variety of network types including the public switched telephone network (PSTN), a cellular telephone network, and a packet switched network (e.g., the Internet). Although only one client device 110, one search provider 170, one application provider 180, and one application engine 165 are shown in FIG. 1, there is no limit to the number of client devices 110, search providers 170, application providers 180, and application engines 165 that may be supported.

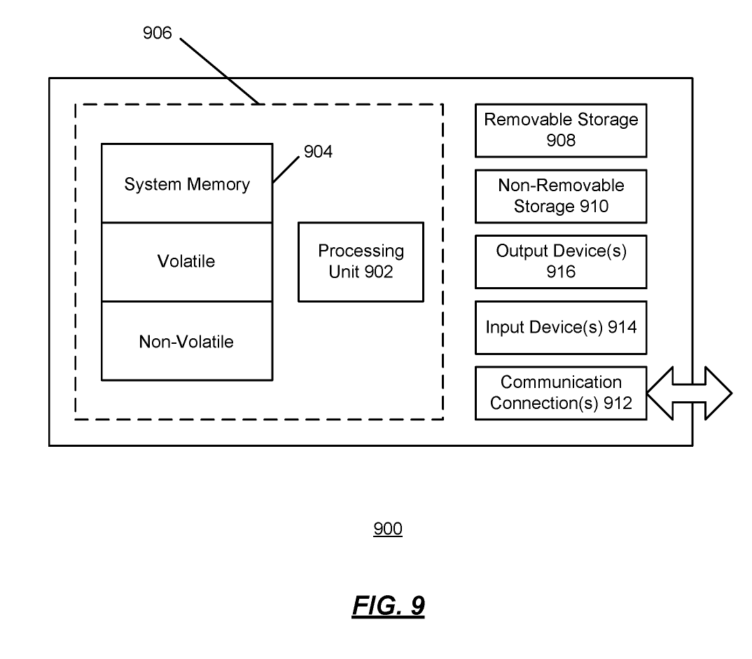

The client device 110 and the application engine 165 may be implemented using a variety of computing devices such as smartphones, desktop computers, laptop computers, tablets, set top boxes, vehicle navigation systems, and video game consoles. Other types of computing devices may be supported. A suitable computing device is illustrated in FIG. 9 as the computing device 900.

Each client device 110 may generate one or more queries 115 for one or more of the search providers 170. A query 115 may include one or more terms. A user of the client device 110 may enter the one or more terms of the query 115 into an application executing on the client device 110 such as a web browser or a map application. For example, a user of a map application may enter a query 115 for a nearby restaurant such as “restaurants within one mile”, or a user of a web browser may enter a query 115 for foreign films such as “Top French films.”

The client device 110 may provide the generated query 115 to a search provider 170, and the search provider 170 may generate and provide results 175 in response to the query 115. The provided results 175 and the search provider 170 that receives the query 115 may depend on the application that was used to generate the query 115. Continuing the example above, when the user enters the query 115 “Top French films” into their web browser, the client device 110 may provide the query 115 to a search provider 170 used by web browsers. The search provider 170 may use a search corpus to determine web pages or other content items that match the query 115, and may provide results 175 that include links or URLs associated with the determined web pages or content items. The results 175 may be presented to the user by the client device 110.

Depending on the implementation, each query 115 may include one or both of a date 119 and a location 117. The date 119 may be the current date and/or time when the user generated the query 115. The location 117 may be a current location of the user or client device 110. The location 117 may be determined by a GPS or other location determination component associated with the client device 110. Alternatively or additionally, the location 117 may be provided or entered by the user.

Each client device 110 may further download one or more applications 185 from one or more of the application providers 180. Each application provider 180 may allow a user of the client device 110 to browse applications 185 that are available to download from the application provider 180. An example application provider 180 is the application store associated with many smartphone and tablet computers.

Each search provider 170 may generate and maintain search histories 177 for users of the search provider 170. A search history 177 for a user may be a record of each of the queries 115 that were provided by the user, along with other information associated with each query 115 such as the location 117 and the date 119.

Similarly, each application provider 180 may generate and maintain an application history 187 for users of the application provider 180. An application history 187 for a user may be a record of each application 185 that was downloaded by the user to a client device 110 associated with the user. Depending on the implementation, other information may also be included in the application history 187 such as whether or not the user used each application 185, whether or not the user has deleted each application 185, and any ratings that the user may have provided for each application 185.

As may be appreciated, the contents of the search history 177 and the application history 187 may be personal and private. Accordingly, to protect the privacy of each user, both the search history 177 and the application history 187 may be encrypted. Moreover, before any information that is used to generate the search history 177 and the application history 187 is collected and used, each user may be asked to opt-in or otherwise consent to the collection and use of such information.

As described above, one drawback associated with many application providers 180 is that because of the large number of applications 185 that are available, it may be difficult for a user of a client device 110 to discover applications 185 that they are interested in, and for the user to learn about new applications 185 that are available. To help solve these and other problems, the environment 100 may further include the application engine 165.

The application engine 165 may use the search histories 177 and application histories 187 to correlate queries 115 from the search histories 177 with applications 185 from the application histories 187, to identify queries 115 that when submitted by users are predictive or the applications 185 that are downloaded by the users. These identified queries 115 can be used to generate recommendations 169 for the related applications 185 to users who provide (or previously provided) one or more of the identified queries 115. Depending on the implementation, the recommendation 169 for a user may be an alert or notification that is displayed or rendered on the client device 110 associated with the user and that indicates one or more applications 185. Alternatively, the recommendation 169 may be functionality that causes the one or more applications 185 to be automatically downloaded to a client device 110 associated with the user.

For example, the application engine 165 may correlate the search histories 177 with the application histories 187, and may determine that 50% of users who provided a query 115 for a particular soccer team also downloaded a particular soccer related application 185. Based on this determination, when a query 115 is received from a user that includes the name of the soccer team, the application engine 165 may generate a recommendation 169 that includes the soccer related application 185.

Depending on the implementation, rather than generate the recommendations 169 in response to current queries 115, the application engine 165 may generate the recommendations 169 based on search histories 177. When the user connects to the application provider 180 (e.g., application store), the application provider 180 may compare the queries 115 from the search history 177 of the user with the queries 115 that were identified as being predictive of downloading one or more applications 185. These applications 185 may be included in the recommendation 169 that is provided to the user.

Continuing the example above, when the user connects to the application provider 180, the application engine 165 may retrieve the application history 187 of the user, and determine that at some point in the past, the user provided a query 115 for the particular soccer team. Based on this determination, the application engine 165 may generate a recommendation 169 that includes the soccer related application 185.

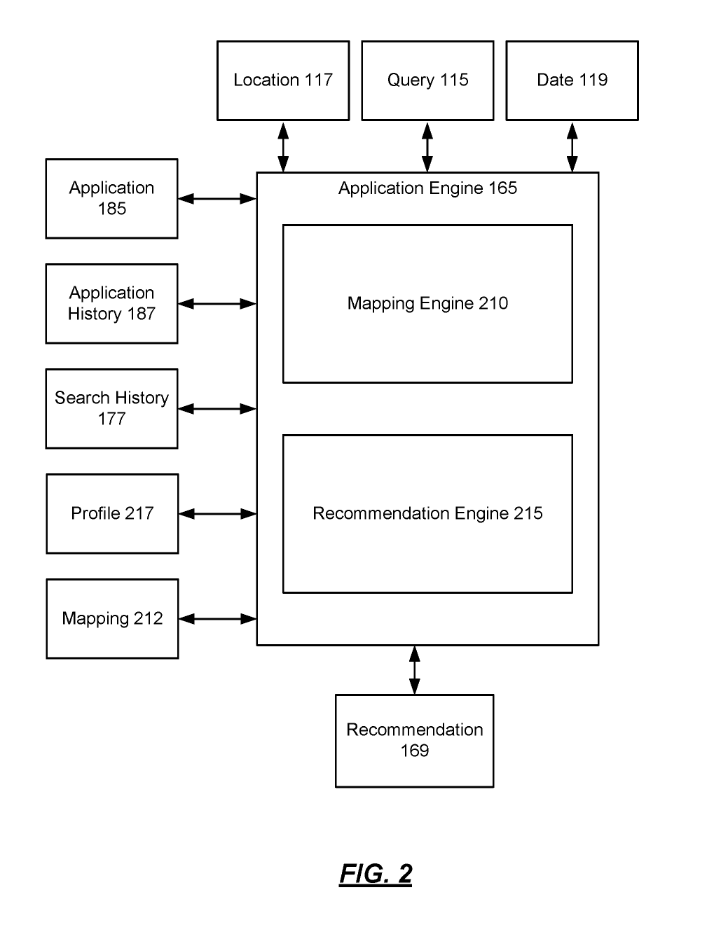

FIG. 2 is an illustration of an implementation of an exemplary application engine 165. The application engine 165 may include one or more components including a mapping engine 210 and a recommendation engine 215. More or fewer components may be included in the application engine 165. Some or all of the components of the application engine 165 may be implemented by one or more computing devices such as the computing device 900 described with respect to FIG. 9. In addition, some or all of the functionality attributed to the application engine 165 may be performed by one or more of the search provider 170, the application provider 180, or the client device 110.

The mapping engine 210 may receive a search history 177 for each user of the application engine 165. The search history 177 for a user may be a list of some or all of the queries 115 that were submitted by the user to one or more search providers 170. Each query 115 in the search history 177 may include a location 117 of where the user was when they submitted the query 115, and a date 119 of when the user submitted the query 115. Other information may be included in the search history 177. Rather than receive the search history 177 from a search provider 170, the mapping engine 210 may receive the queries 115 that were submitted for a user, and may generate the search history 177 for the user from the received queries 115.

The search histories 117 received for each user may be complete search histories 177 or may be partial search histories 177. A complete search history 177 may include all of the queries 115 that were provided by a user, while a partial search history 177 may include only a subset of the queries 115 that were provided by the user. Depending on the implementation, the partial search histories 177 may include the most recent queries 115, and may be limited to queries 115 provided by the user in the last week, month, or year, for example. The dates used to limit the search histories 177 may be set by a user or an administrator, for example.

The mapping engine 210 may receive an application history 187 for each user of the application engine 165. The application history 187 for a user may be a list of some or all of the applications 185 that were downloaded by the user from one or more application providers 180. Each application history 187 may include additional information such as a date when each application 185 was downloaded, information indicating how much the user has used each application 185, and any ratings or scores assigned to each application 185 by the user. Depending on the implementation, each application history 187 may be generated by the application provider 180, or by the mapping engine 210.

Similar to the search histories 177, the application histories 187 received for each user may be complete application histories 187, or may be partial application histories 187. Depending on the implementation, the partial application histories 187 may include the most recent applications 185 that were downloaded by the users (e.g., downloaded in the last week, month, or year). The dates used to limit the application histories 187 may be set by a user or an administrator, for example.

The mapping engine 210 may correlate the search histories 177 with the application histories 187 to identify queries 115 that are predictive of application 185 downloads. For example, if 80% of users who submitted a query 115 of “pizza” later downloaded an application 185 that corresponds to a pizza restaurant, then the query 115 “pizza” may be identified as being predictive of a user downloading the application 185 corresponding to the pizza restaurant. In another example, if 12% of users who submitted a query 115 of “motorcycle” downloaded a motorcycle racing game application 187, then the query 115 of “motorcycle” may not be identified as being predictive of a user downloading the motorcycle racing game application 185. The particular threshold percentage may be set by a user or an administrator, for example.

Depending on the implementation, when a query 115 is identified as being predictive of downloading a particular application 185, the mapping engine 210 may additionally determine whether downloading the particular application 185 is also predictive of a user providing the identified query 115. Popular applications 185 may be downloaded by a large number of users, and therefore many queries 115 may appear to be predictive of downloading popular applications 185 even where they are unrelated. Where a query 115 is identified as being predictive of downloading a particular application 185, but the particular application 185 is not also predictive of the query 115, the identified query 115 may no longer be considered when recommending the particular application 185. The threshold percentage used to determine if an application 185 is predictive of a query 115 may similarly be selected by a user or an administrator, and may be the same or less than the threshold percentage used to identify queries 115.

Alternatively, rather than determine if applications 185 are also predictive of their identified queries 115, the mapping engine 210 may eliminate popular applications 185 from consideration. For example, if an application 185 has already been downloaded by some threshold percentage of users (e.g., 20%, 30%, or 40%), then there may be no reason to recommend the application 185 regardless of the queries 115 that are submitted by the users. The threshold percentage may be set by a user or an administrator. Similarly, queries 115 that are very popular or that are disproportionally submitted by users may be not considered for application 185 recommendations.

In some implementations, the locations 117 associated with the queries 115 may be considered, and the mapping engine 210 may determine query 115 and location 117 pairs that are predictive of downloading applications 185. Continuing the pizza example above, users with locations 117 that are in New York who submit the query 115 “pizza” may be likely to download an application 185 associated with a regional New York pizza chain, and users with locations 117 that are in Phoenix may be likely to download an application 185 associated with a regional Phoenix pizza chain. Other information such as the dates 119 associated with the queries 115 may also be considered by the mapping engine 210.

The mapping engine 210 may further consider a profile 217 associated with some or all of the users when identifying queries 115 that are predictive of application 185 downloads. A profile 217 may include demographic information about each user and may include information that is indicative of the interests of the user. Continuing the “motorcycle” query 115 example described above, users whose profiles 217 identify them as “garners” (i.e., videogame aficionados) and who submitted the query 115 “motorcycle” may be much more likely to download the motorcycle racing game application 185 than users whose profiles 217 do not identify them as garners.

The mapping engine 210 may use the identified queries 115 that are predictive of application 185 downloads to generate a mapping 212. The mapping 212 may be a mapping from queries 115 to the applications 185 that they are predictive of downloading. In some implementations, the mapping 212, for each query 115 to application 185 mapping, may include an indication of the strength of the mapping between the query 115 and the application 185. The strength may be based on a probability or likelihood that a user who provided the query 115 also downloaded the application 185. Alternatively, the strength may be based on how much more likely a user who provided the query 115 is to have downloaded the application 185 than a user who did not provide the query 115.

Where the mapping engine 210 considered other information when identifying queries 115 and applications 185, such as locations 117, dates 119, and profiles 217, this information may also be included in the mapping 212. Any method for creating a mapping 212 may be used.

The recommendation engine 215 may generate recommendations 169 for applications 185 using the mapping 212. In one implementation, the recommendation engine 215 may receive a query 115 that was submitted by a user, and may use the mapping 212 to determine one or more applications 185 that are associated with the query 115 in the mapping 212. Where other information such as a location 117 is included in the query 115, the recommendation engine 215 may use the included information and the query 115 to determine the one or more applications 185 that are associated with the query 115.

In some implementations, the recommendation engine 215 may include links or references to the one or more applications 185 in the recommendation 169. The recommendation engine 215 may provide the recommendation 169 to the client device 110 in response to the query 115. The client device 110 may display graphical representations of the one or more applications 185 to the user, and the user may use the graphical representations to download one or more of the one or more applications 185. Alternatively, the client device 110 may download some or all of the one or more applications 185 to the client device 110 automatically without any action taken by the user.

Depending on the implementation, when multiple applications 185 are determined to be associated with the query 115, the recommendation engine 215 may include links to all of the determined applications 185 in the recommendation 169. Alternatively, the recommendation engine 169 may rank the applications 185, and may include links to a subset of the applications 187 according to the ranking. The recommendation engine 215 may rank the applications 185 based on the strengths of the mappings between the query 115 and each of the applications 185, or may rank the applications 185 using the profile 217 of the user associated with the query 115.

Some applications 185 may be associated with an expiration date. The expiration date may be a date after which the application 185 may not be included as part of a recommendation 169. For example, applications 185 are often created to tie into or promote certain events such as the Olympics or a music festival. After the events are over, the associated applications 185 may no longer be useful and therefore may not be included in a recommendation 169. Accordingly, before a link to an application 185 is included in the recommendation 169, the recommendation engine 215 may determine that the expiration date associated with the application 185 has not passed. The expiration date for an application 185 may be set by a user or an administrator, for example.

In addition, before including links to the applications 185 in the recommendation 169, the recommendation engine 215 may determine if any of the applications 185 have already been downloaded to the client device 110 associated with the user. The recommendation engine 215 may then only include links to the applications 185 that have not already been downloaded by the user to the client device 110. Whether or not an application 185 has been downloaded by a user may be determined by the recommendation engine 215 using the application history 187 associated with the user.

In an example implementation, a user of the client device 110 may search for directions to a famous amusement park named “Daisy Park.” After the user enters the query 115 “Daisy Park”, and directions to the park are displayed to the user at the client device 110, the query 115 may also be provided to the recommendation engine 215. The recommendation engine 215 may use the mapping 212 to determine that users who previously provided the query 115 “Daisy Park” tended to download applications 185 such as the “Official Daisy Park Application” and “Daisy Park Discounts.” Accordingly, the recommendation engine 215 may provide links to the applications 185 in the recommendation 169, and the client device 110 may display the links to the user on the client device 110 with the requested directions. The user may download the applications 185 or may request additional information about the applications 185.

In other implementations, rather than generate recommendations 169 in response to queries 115, the recommendation engine 215 may generate recommendations 169 in response to search histories 177. The recommendation engine 215 may receive a search history 177 for a user of a client device 110, and may extract some or all of the queries 115 from the search history 177. The recommendation engine 215 may use the extracted queries 115 and the mapping 212 to determine one or more applications 185. Links to some or all of the determined one or more applications 185 may be included in the recommendation 169.

As may be appreciated, the search history 177 associated with a user may include a large number of queries 115. Rather than use all of the queries 115 to determine applications 185, the recommendation engine 215 may limit the queries 115 to the most recent queries 115. For example, depending on how many queries 115 are in the search history 177, the recommendation engine 215 may only consider queries 115 from the past week, month, year, etc.

Alternatively or additionally, the recommendation engine 215 may rank each query 115 in the search history 177 based on how many times the query 115 appears in the search history 177. The recommendation engine 215 may select a subset of the queries 115 from the search history 177 according to the ranking. For example, if a query 115 “dogs” appears in the search history 177 ten times and a query 115 “cats” appears in the search history 177 twenty times, then the query 115 “cats” may be ranked higher than the query 115 “dogs” by the recommendation engine 215.

In another implementation, after the applications 185 are identified using the search history 177 and the mapping 212, the recommendation engine 215 may rank the applications 185 based on how many times each application 185 is identified. For example, the mapping 212 may identify the same application 185 for multiple queries 115 from the search history 177. An application 185 that is identified multiple times may be more likely to be relevant to the user than an application 185 that is identified less frequently. The recommendation engine 215 may add the applications 185 to the recommendation 169 according to the ranking.

In an example implementation, a user may connect to an application store associated with an application provider 180 to look for applications 185 that the user would like to download to their client device 110. When the user connects to the application provider 180, the application provider 180 may provide the search history 177 associated with the user to the recommendation engine 215. The recommendation engine 215 may use the mapping 212 and some or all of the queries 115 from the search history 177 to identify one or more applications 185. Links to the identified one or more applications 185 may be displayed to the user as part of the recommendation 169.

As may be appreciated, the application engine 165 provides several advantages. One advantage of the application engine 165 is that users are provided with recommendations 169 for applications 185 in response to their queries 115 without the users having to visit an application store. For example, a user may provide a query 115 for “rental car locations” and may be immediately presented with a recommendation 169 that includes links to one or more application 185 that can be used to rent a car. The user may download one or more of the applications 185. In the past, the user would have to somehow know that the applications 185 exist, and would also have to connect to an application store to download the applications 185.

Another advantage of the application engine 165 is that the search history 177 of the user can be utilized when recommending applications 185, particularly by application stores. For example, in the past, application stores typically allow users to browse lists of applications 185 based on criteria such as “Top Earning” and “Most Downloaded.” Some application stores also provide a list of recommended applications 185 that is based on the application history 187 of the user. However, recommending applications 185 based on the application history 187 of a user may not be useful for a user who has downloaded few applications 185. In addition, the search history 177 of a user may better reflect the true and diverse interests of the user than the application history 187 of the user.

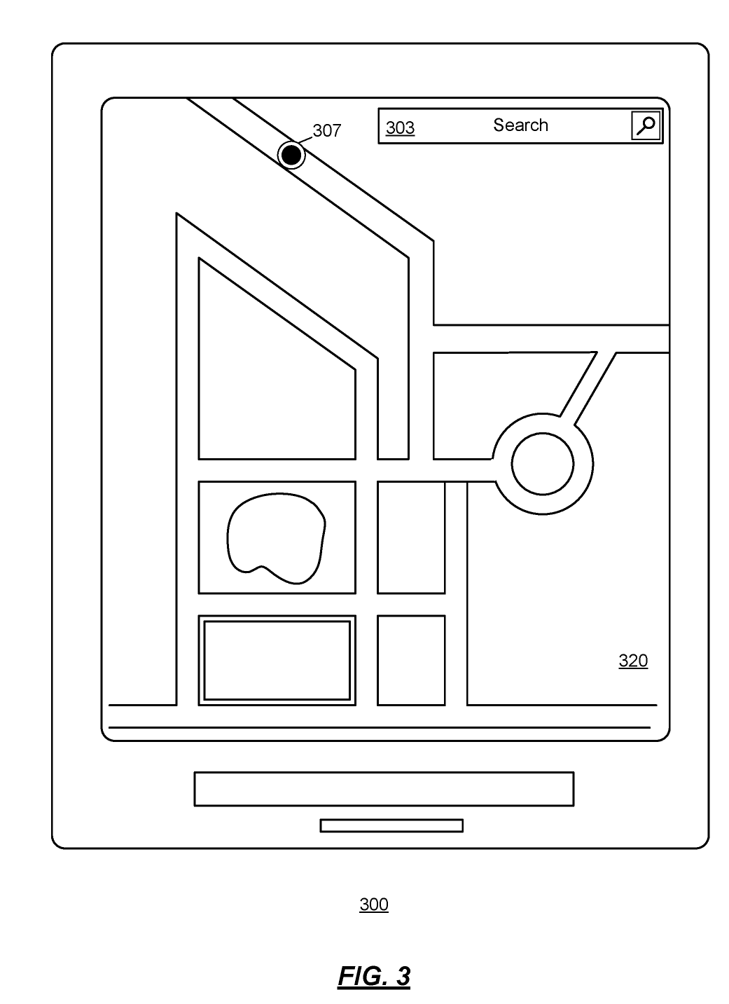

FIG. 3 is an illustration of an example user interface 300 for providing a query 115 and for receiving a recommendation 169 for an application 185 based on the query 115. The user interface 300 may be implemented by a client device 110 associated with a user. As shown, the user interface 300 is displayed on a tablet computing device. However, the user interface 300 may also be displayed by other computing devices such as smartphones and vehicle navigation systems, etc.

As shown in a window 320, a user is viewing a map using a map application. The map application may be similar to the map application included in many smartphones. The current location of the user on the map is shown in the window 320 by an icon 307. The location of the user may be determined using a GPS or other location determination component associated with the client device 110. The user interface 300 further includes a user interface element 303. The user interface element 303 may allow the user to provide one or more queries 115.

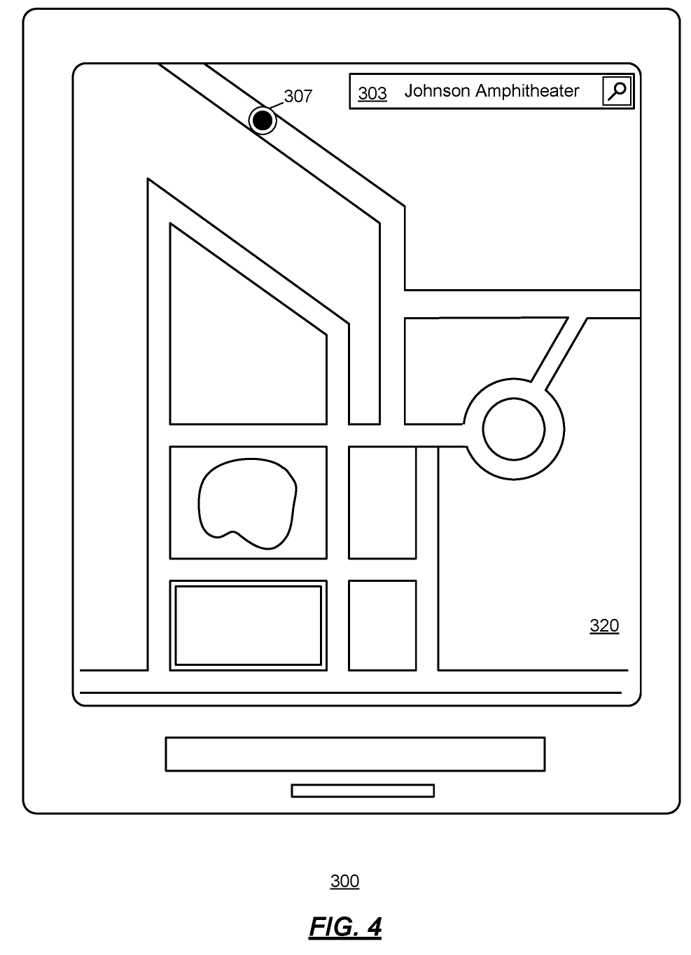

Continuing to FIG. 4, the user may be visiting a new city to attend an event called “Spring Festival” that occurs every year and is located at a venue called “Johnson Amphitheater.” The user may not know where the venue is located and has provided the query 115 “Johnson Amphitheater” into the user interface element 303.

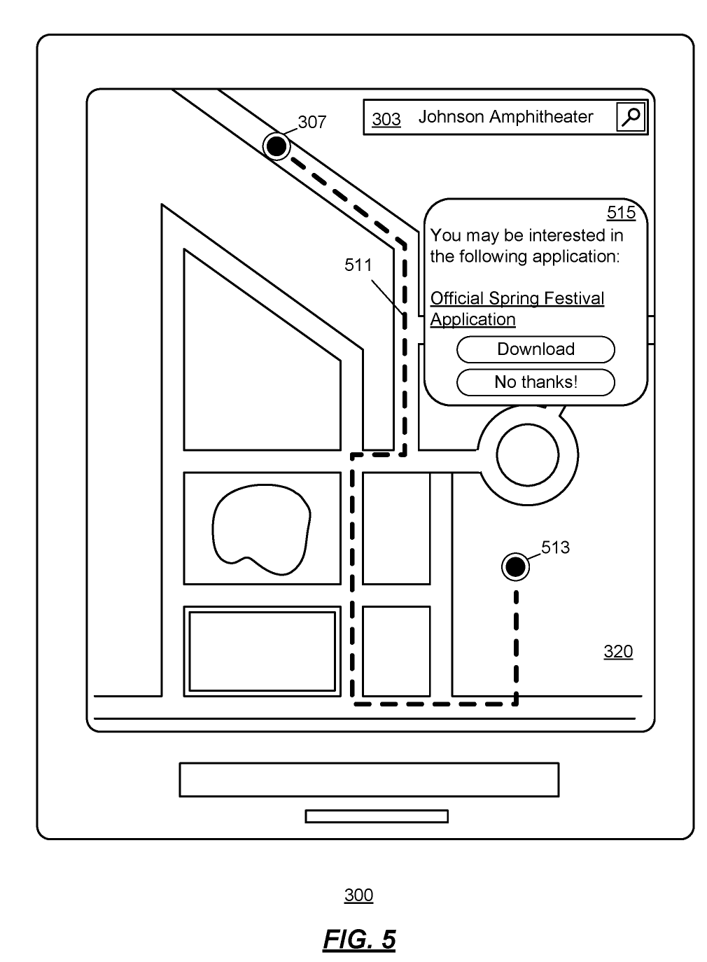

Continuing to FIG. 5, the client device 110 has provided the query 115 “Johnson Amphitheater” to a search provider 170 associated with the map application, and the search provider 170 has provided results 175 that include the location of the venue and directions from the current location of the client device 110 to the venue. The location of the venue has been rendered and displayed in the window 320 as an icon 513. The directions from the location of the user to the venue is rendered and displayed in the window 320 using the dotted line 511.

In addition, the query 115 was provided to the application engine 165, and the query 115 was used, along with the current location of the client device 115 and the mapping 212, to determine an application 185 that was downloaded by other users who provided the query 115 of “Johnson Amphitheater” from a location that was near the location associated with the client device 110. An indicator of the determined application 185 was provided to the client device 110 as part of a recommendation 169.

In the example shown, the determined application 185 is an application titled “Official Spring Festival Application” and a link to the application 185 is rendered and displayed to the user in the window 320 as part of a user interface element 515. The user may download the application 185 by selecting the user interface element labeled “Download”, or may choose not to download the application 185 by selecting the user interface element labeled “No thanks!”.

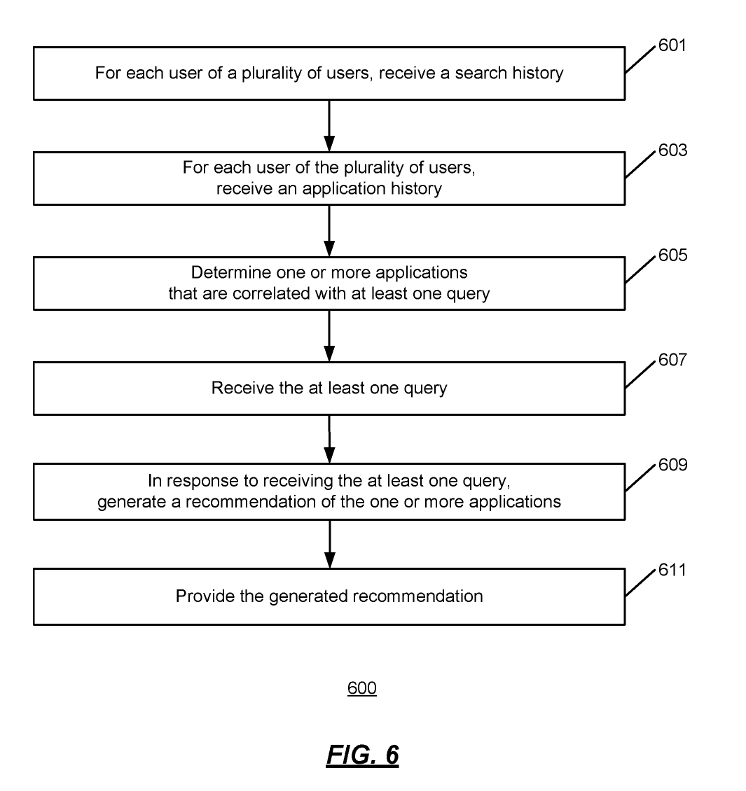

FIG. 6 is an operational flow of an implementation of a method 600 for recommending one or more applications based on a received query. The method 600 may be implemented by the application engine 165.

At 601, a search history is received for each user of a plurality of users. The search histories 177 may be received by the mapping engine 210 from one or more search providers 170. Depending on the implementation, a search history 177 for a user may include a plurality of queries 115 that were provided to a search provider 170 by the user. Each query 115 may further be associated with a location 117 from which the user submitted the query 115 and a date 119 that the user submitted the query 115. Other information may be included.

At 603, an application history is received for each user of the plurality of users. The application histories 187 may be received by the mapping engine 210 from one or more application providers 180. Depending on the implementation, an application history 187 for a user may include a plurality of applications 185 that were downloaded to a client device 110 associated with the user. Each application 185 may be associated with information such as when the application 185 was downloaded, how many times or how often the user used the application 185, and whether or not the application 185 is still stored or installed on a client device 110. Other information may be included.

At 605, one or more applications that are correlated with at least one query are determined. The one or more applications 185 that are correlated with at least one query 115 may be determined by the mapping engine 210 using the queries 115 from the search histories 177 and the applications 185 from the application histories 187 received for each user. Depending on the implementation, an application 185 is correlated with a query 115 if more than a threshold percentage of users that submitted the query 115 went on to later download the application 185. The threshold percentage may be set by a user or an administrator, for example. Depending on the implementation, the determined one or more applications 185 that are correlated with the at least one query 115 may be used by the mapping engine 210 to form a mapping 212.

At 607, the at least one query is received. The at least one query 115 may be received by the recommendation engine 215 from a user of a client device 110. The user may provide the query 115 using an application such as a web browsing application or a map application, for example. The query 115 may be provided to a search provider 170 as well as the application engine 165.

At 609, a recommendation of the one or more applications is generated. The recommendation 169 may be generated by the recommendation engine 215 using the correlation of the at least one query 115 to the one or more applications 185 from the mapping 212. The recommendation 169 may include a link or reference to the one or more applications 185 at one or more application providers 180.

At 611, the recommendation is provided. The recommendation 169 may be provided by the application engine 165 to the client device 110 that provided the at least one query 115. Links to the one or more applications 185 of the recommendation 169 may be presented to the user of the client device 110 along with any results 175 associated with the query 115 from the search provider 170. The user may download the one or more applications 185 by selecting the links. Alternatively, the one or more applications 185 may be automatically downloaded to the client device 110.

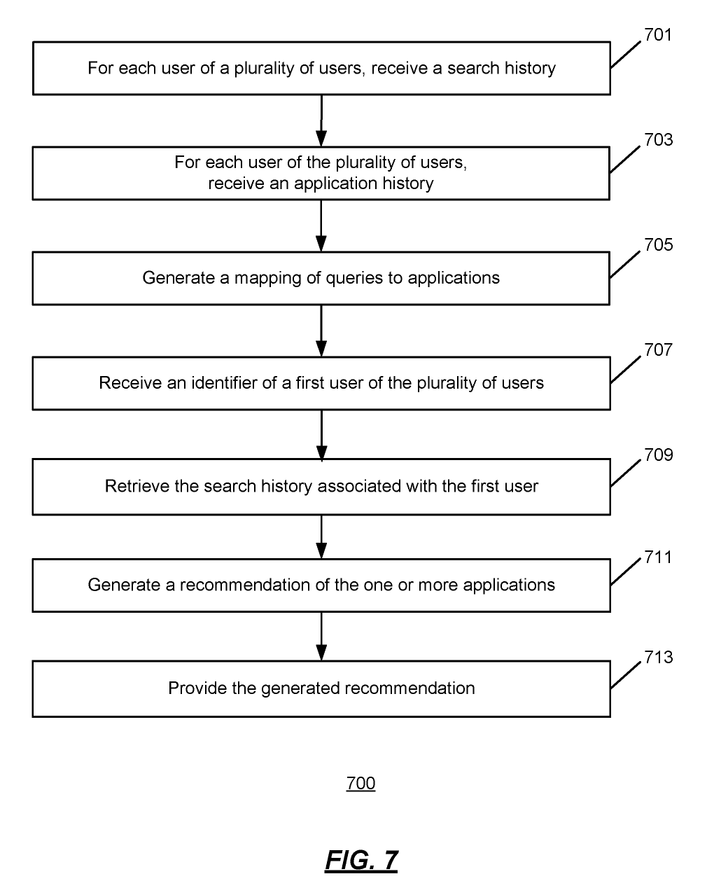

FIG. 7 is an operational flow of an implementation of a method 700 for recommending one or more applications based on a search history 177. The method 700 may be implemented by the application engine 165.

At 701, a search history is received for each user of a plurality of users. The search histories 177 may be received by the mapping engine 210 from one or more search providers 170. Alternatively, the mapping engine 210 may receive queries 115 provided by each user to one or more search providers 170, and the mapping engine 210 may generate the search histories 177 from the queries 115. Depending on the implementation, the search histories 177 may be limited to recent queries 115 (e.g., past week, past month, or past year).

At 703, an application history is received for each user of the plurality of users. The application histories 187 may be received by the mapping engine 210 from one or more application providers 180. Alternatively, the mapping engine 210 may generate the application history 187 for each user. The application histories 187 may include, or may not include, applications 185 that were downloaded but later deleted. Like the search histories 177, the application histories 187 may be limited to recently downloaded applications 185.

At 705, a mapping of queries to applications is generated. The mapping 212 may be generated by the mapping engine 210 using the search histories 177 and application histories 187 received for each user. In some implementations, the mapping engine 210 may generate the mapping by determining what queries 115 from the search histories 177 are correlated with the downloading of one or more applications 185 from the application histories 187. In particular, the mapping engine 210 may determine what queries 115, that when submitted by a user, are predictive of the user later downloading particular applications 185. The determined queries 115 and associated applications 185 may be saved as the mapping 212.

At 707, an identifier of a first user of the plurality of users is received. The identifier of the first user may be received by the application engine 165. The identifier of the first user may be received from an application provider 180. For example, the first user may have connected to an application store associated with the application provider 180 using a client device 110 associated with the user.

At 709, the search history associated with the first user is retrieved. The search history 177 associated with the first user may be retrieved by the recommendation engine 215 of the application engine 165.

At 711, a recommendation of the one or more applications is generated. The recommendation 169 may be generated by the recommendation engine 215 using the mapping 212 and the search history 177.

At 713, the recommendation is provided. The recommendation 169 may be provided by the application engine 165 to the application provider 180 associated with the application store. Links to the one or more applications 185 of the recommendation 169 may be presented to the user at the application store as recommended applications 185. For example, the application store may display the links to the one or more applications 185 in a section of the application store called “Recommended based on your search history” or “Users with a similar search history also downloaded”.

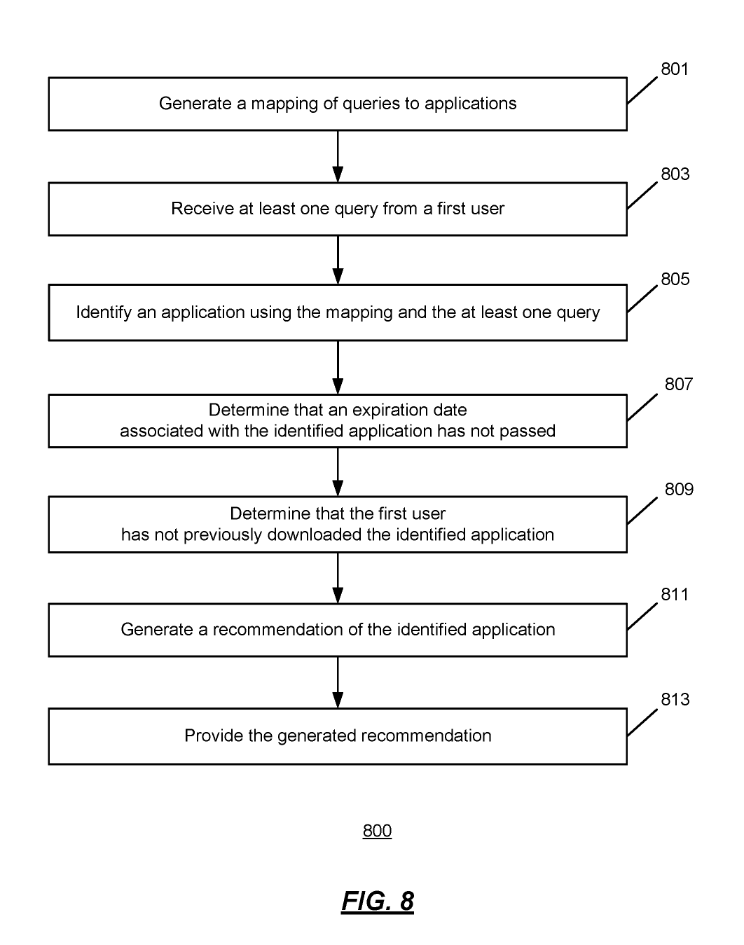

FIG. 8 is an operational flow of an implementation of a method 800 for recommending an application that a user has not previously downloaded and whose expiration date has not passed based on search histories and application histories. The method 800 may be implemented by the application engine 165.

At 801, a mapping of queries to applications is generated. The mapping 212 may be generated by the mapping engine 210 using one or more search histories 177 and one or more application histories 187 received for a plurality of users. The mapping 212 may be used to identify one or more applications 185 that a user may be interested in downloading based on a query 115 provided by the user, or based on a search history 177 associated with the user.

At 803, at least one query is received from a first user. The at least one query 115 may be received by the recommendation engine 215 from a client device 110 associated with the first user.

At 805, an application is identified using the mapping and the at least one query. The application may be identified using the mapping 212 by the recommendation engine 215.

At 807, it is determined that an expiration date associated with the identified application has not passed. That the expiration date has not passed may be determined by the recommendation engine 215. The expiration date may be the date after which the identified application 185 may no longer relevant or useful, and therefore should not be recommended. For example, an application 185 directed to a festival may have an expiration date that is the day after the festival has ended.

At 809, it is determined that the first user has not previously downloaded the identified application. That the first user has not previously downloaded the identified application 185 may be determined by the recommendation engine 215 using the application history 187 associated with the first user.

At 811, a recommendation of the identified application is generated. The recommendation 169 may be generated by the recommendation engine 215 and may include a link to the identified application 185.

At 813, the generated recommendation is provided. The recommendation 169 may be provided by the application engine 165 to the client device 110 associated with the first user. The link to the identified application 185 may be displayed to the first user. Alternatively, the client device 110 may cause the identified application 185 to be automatically downloaded to the client device 110 associated with the user.

FIG. 9 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 9, an exemplary system for implementing aspects described herein includes a computing device, such as computing device 900. In its most basic configuration, computing device 900 typically includes at least one processing unit 902 and memory 904. Depending on the exact configuration and type of computing device, memory 904 may be volatile (such as random access memory (RAM)), non-volatile (such as read-only memory (ROM), flash memory, etc.), or some combination of the two. This most basic configuration is illustrated in FIG. 9 by dashed line 906.

Computing device 900 may have additional features/functionality. For example, computing device 900 may include additional storage (removable and/or non-removable) including, but not limited to, magnetic or optical disks or tape. Such additional storage is illustrated in FIG. 9 by removable storage 908 and non-removable storage 910.

Computing device 900 typically includes a variety of computer readable media. Computer readable media can be any available media that can be accessed by the device 900 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 904, removable storage 908, and non-removable storage 910 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media may be part of computing device 900.

Computing device 900 may contain communication connection(s) 912 that allow the device to communicate with other devices. Computing device 900 may also have input device(s) 914 such as a keyboard, mouse, pen, voice input device, touch input device, etc. Output device(s) 916 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a system for recommending applications based on search histories and application histories is provided. The system includes at least one computing device and an application engine. The application engine may be adapted to: for each user of a plurality of users, receive a search history for the user, wherein the search history for each user of the plurality of users comprises a plurality of queries submitted by the user of the plurality of users; for each user of the plurality of users, receive an application history for the user, wherein the application history for each user of the plurality of users comprises a plurality of applications downloaded by the user; using the received search histories and the received application histories, determine one or more applications of the received application histories that are correlated with at least one query from one or more of the received search histories; receive the at least one query from a first user of the plurality of users; and in response to receiving the at least one query from the first user of the plurality of users, generate a recommendation of the one or more applications that are correlated with the at least one query.

Implementations may include some or all of the following features. The application engine may be further adapted to display a link to the one or more applications on a device associated with the first user. The application engine may be further adapted to provide the recommendation to a device associated with the first user. The application engine may be further adapted to cause the one or more applications to be downloaded to a device associated with the first user. The application engine may be further adapted to determine that the one or more applications have not been downloaded previously to a device associated with the first user. The application engine may be adapted to determine that an expiration date associated with any of the one or more applications has not passed. The search history for each user of the plurality of users may include a location and a date associated with each query of the plurality of queries submitted by the user. The search history for each user may be received from one or more of a map application or a web browsing application.

In an implementation, a system for recommending applications based on search histories and application histories is provided. The system may include at least one computing device and an application engine. The application engine may be adapted to: for each user of a plurality of users, receive a search history for the user, wherein the search history for each user of the plurality of users comprises a plurality of queries submitted by the user of the plurality of users; for each user of the plurality of users, receive an application history for the user, wherein the application history for each user of the plurality of users comprises a plurality of applications downloaded by the user; using the received search histories and the received application histories, generate a mapping of queries from the received search histories to applications from the received application histories; receive an identifier of a first user of the plurality of users; retrieve a search history of the first user; using the search history of the first user and the generated mapping, identify one or more applications from the received application histories; and generate a recommendation of the one or more applications.

Implementations may include some or all of the following features. The application engine may be further adapted to display a link to the one or more applications on a device associated with the first user. The application engine may be further adapted to provide the recommendation to a device associated with the first user. The application engine may be further adapted to cause the one or more applications to be downloaded to a device associated with the first user. The application engine may be adapted to determine that the one or more applications have not been downloaded previously to a device associated with the first user. The application engine may be adapted to determine that an expiration date associated with any of the one or more applications has not passed. The search history for each user of the plurality of users may include a time associated with each query of the plurality of queries submitted by the user. The generated mapping may include a mapping of queries and times to applications. The search history for each user of the plurality of users further may include a location associated with each query of the plurality of queries submitted by the user. The generated mapping may include a mapping of queries and locations to applications.

In an implementation, a method for recommending applications based on search histories and application histories is provided. The method includes: for each user of a plurality of users, receiving a search history for the user by a first computing device, wherein the search history for each user of the plurality of users comprises a plurality of queries submitted by the user of the plurality of users; for each user of the plurality of users, receiving an application history for the user by the first computing device, wherein the application history for each user of the plurality of users comprises a plurality of applications downloaded by the user; using the received search histories and the received application histories, generating a mapping of queries from the received search histories to applications from the received application histories by the first computing device; receiving at least one query from a first user of the plurality of users by the first computing device; using the received at least one query and the generated mapping, identifying an application from the received application histories by the first computing device; determining that the first user has not previously downloaded the identified application to a second computing device based on the application history associated with the first user by the first computing device; and in response to the determination, generating a recommendation of the identified application by the first computing device.

Implementations may include some or all of the following features. The method may further include displaying a link to the identified application on the second computing device. The method may further include causing the identified application to be downloaded to the second computing device. The method may further include determining that an expiration date associated with the identified application has not passed. The search history for each user may be received from one or more of a map application or a web browsing application.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for recommending applications based on search histories and application histories, the system comprising:
a computing device; and
an application engine adapted to:
for each user of a plurality of users, receive a search history for the user, wherein the search history for each user of the plurality of users comprises a plurality of queries submitted by the user of the plurality of users;
for each user of the plurality of users, receive an application history for the user, wherein the application history for each user of the plurality of users comprises a plurality of applications downloaded by the user;
using the received search histories and the received application histories, determine one or more applications of the received application histories that are correlated with at least one query from one or more of the received search histories;
receive the at least one query from a first user of the plurality of users; and
in response to receiving the at least one query from the first user of the plurality of users, generate a recommendation of the one or more applications that are correlated with the at least one query.

2. The system of claim 1, wherein the application engine is further adapted to display a link to the one or more applications on a device associated with the first user.

3. The system of claim 1, wherein the application engine is further adapted to cause the one or more applications to be downloaded to a device associated with the first user.

4. The system of claim 1, wherein the application engine adapted to generate the recommendation comprises the application engine adapted to determine that the one or more applications have not been downloaded previously to a device associated with the first user.

5. The system of claim 1, wherein the application engine adapted to generate the recommendation comprises the application engine adapted to determine that an expiration date associated with any of the one or more applications has not passed.

6. The system of claim 1, wherein the search history for each user of the plurality of users further comprises a location and a date associated with each query of the plurality of queries submitted by the user.

7. The system of claim 1, wherein the search history for each user is received from one or more of a map application or a web browsing application.

8. A system for recommending applications based on search histories and application histories, the system comprising:
a computing device; and
an application engine adapted to:
for each user of a plurality of users, receive a search history for the user, wherein the search history for each user of the plurality of users comprises a plurality of queries submitted by the user of the plurality of users;
for each user of the plurality of users, receive an application history for the user, wherein the application history for each user of the plurality of users comprises a plurality of applications downloaded by the user;
using the received search histories and the received application histories, generate a mapping of queries from the received search histories to applications from the received application histories;
receive an identifier of a first user of the plurality of users;
retrieve a search history of the first user;
using the search history of the first user and the generated mapping, identify one or more applications from the received application histories; and
generate a recommendation of the one or more applications.

9. The system of claim 8, wherein the application engine is further adapted to display a link to the one or more applications on a device associated with the first user

10. The system of claim 8, wherein the application engine is further adapted to provide the recommendation to a device associated with the first user.

11. The system of claim 8, wherein the application engine is further adapted to cause the one or more applications to be downloaded to a device associated with the first user.

12. The system of claim 8, wherein the application engine adapted to generate the recommendation comprises the application engine adapted to determine that the one or more applications have not been downloaded previously to a device associated with the first user.

13. The system of claim 8, wherein the application engine adapted to generate the recommendation comprises the application engine adapted to determine that an expiration date associated with any of the one or more applications has not passed.

14. The system of claim 8, wherein the search history for each user of the plurality of users further comprises a time associated with each query of the plurality of queries submitted by the user, and the generated mapping comprises a mapping of queries and times to applications.

15. The system of claim 8, wherein the search history for each user of the plurality of users further comprises a location associated with each query of the plurality of queries submitted by the user, and the generated mapping comprises a mapping of queries and locations to applications.

16. A method for recommending applications based on search histories and application histories, the method comprising:
for each user of a plurality of users, receiving a search history for the user by a first computing device, wherein the search history for each user of the plurality of users comprises a plurality of queries submitted by the user of the plurality of users;
for each user of the plurality of users, receiving an application history for the user by the first computing device, wherein the application history for each user of the plurality of users comprises a plurality of applications downloaded by the user;
using the received search histories and the received application histories, generating a mapping of queries from the received search histories to applications from the received application histories by the first computing device;
receiving at least one query from a first user of the plurality of users by the first computing device;
using the received at least one query and the generated mapping, identifying an application from the received application histories by the first computing device;
determining that the first user has not previously downloaded the identified application to a second computing device based on the application history associated with the first user by the first computing device; and
in response to the determination, generating a recommendation of the identified application by the first computing device.

17. The method of claim 16, further comprising displaying a link to the identified application on the second computing device.

18. The method of claim 16, further comprising causing the identified application to be downloaded to the second computing device.

19. The method of claim 16, further comprising determining that an expiration date associated with the identified application has not passed.

20. The method of claim 16, wherein the search history for each user is received from one or more of a map application or a web browsing application.
